(19) United States
(12) Patent Application Publication
(10) Pub. No.: US 2004/0093390 A1
(43) Pub. Date: May 13, 2004

(54) Connected memory management

(76) Inventor: Matthias Oberdorfer, Fort Collins, CO (US)

Correspondence Address: COCHRAN FREUND & YOUNG LLC, 3555 STANFORD ROAD, SUITE 230, FORT COLLINS, CO, 80525, US

(21) Appl. No.: 10/293,792

(22) Filed: Nov. 12, 2002

(51) Int. Cl. G06F 15/167

(52) U.S. Cl. 709/216

(57) ABSTRACT

A multi-node computing cluster uses a table of data objects within each process to determine if a data object is locally available or on a remote computing node. For those data objects located remotely, a local handler process is able to communicate with a remote handler process on a remote node. The remote handler is capable of retrieving and sending the data object directly from or to the memory of a second process without disturbing the second process, thereby allowing the second process to continually compute. The remote handler may transfer the data object to the local handler, which in turn may place the data object into the memory of the first process.

### CROSS REFERENCE TO RELATED APPLICATIONS

The present application is filed simultaneously with application Ser. No. ______ entitled “Scalable Parallel Processing on Shared Memory Computers” by the present inventor, Matthias Oberdorfer, filed Nov. 12, 2002, the full text of which is hereby specifically incorporated by reference for all it discloses and teaches.

### BACKGROUND OF THE INVENTION

a. Field of the Invention

The present invention pertains to multiprocessor computation and specifically to memory that may be accessed by several processors.

b. Description of the Background

Parallel computers can be broadly divided into shared memory parallel computers and distributed memory parallel computers. Each system has distinct disadvantages.

Shared memory parallel computers have multiple processors that access a single shared memory bank. Shared memory parallel computers are limited as to the number of processors that may be linked via a high speed bus. In general, the processors are located on a single printed circuit board or attached to a single backplane. All of the processors have equal, relatively unrestricted access to all of the available memory. The expandability of such systems is very limited. Further, such systems that have more than 16-64 processors are built in very low volume and tend to be quite costly.

Distributed memory parallel computers generally have separate relatively low-cost processors with separate memory on separate printed circuits. Such systems are generally connected via dedicated network technology such as Ethernet or other comparable technologies. Methods for distributed memory parallel computers include message passing and virtual memory.

Message passing for distributed memory relies on individual messages being passed between processors for requests for certain data. When one processor needs data that is stored on another computer, a rather complex interaction must be performed to transfer the needed memory information to the requesting processor. Programs must be specifically written to take advantage of the message passing model and are not readily transferred to other platforms. Further, there can be substantial overhead associated with the passing of messages between processors.

Virtual memory models simulate shared memory, however the various pages of memory are located on different computers. When a page fault occurs, the needed page of memory must be sent from one computer to another. While virtual memory models are simple to program and are readily scalable, the overhead in transferring entire pages of memory seriously undermines the overall performance of the system.

It would therefore be advantageous to provide a system and method for parallel computing wherein multiple shared memory parallel computers that are connected as a distributed memory parallel computer system may be able to share memory without large amounts of memory transfer overhead. It would be further advantageous to provide a system that is scalable without specially configuring software to take advantage of increased number of processors or memory. Furthermore it would be advantageous to provide a system and method that works transparently for shared memory parallel computers, distributed parallel computers or a combination of both.

### SUMMARY OF THE INVENTION

The present invention overcomes the disadvantages and limitations of the prior art by providing a system and method for combining many multiprocessor computer systems with independent memory into a distributed multiprocessor system. Each computer system may have one or more processors and may have a memory handler process continually running. Further, each process may have a lookup table where various data may be stored. In some cases, the data may be on the same computer where the process is running, and in other cases the data may be located on a second computer. The memory handler process may be adapted to efficiently communicate with a memory handler process on the second computer where the data is stored. The data may be transferred to the first computer without disturbing any other process that may be functioning on the second computer.

The present invention may therefore comprise a method of sharing data between two processes on a multi-node computing cluster comprising the steps of: determining that a data object needs to be updated by a first process operating on a first node of the cluster; querying a lookup table to determine that the data object is located in a second process running on another computing node of the cluster, the lookup table having at least the location of data objects as either on the first computing node or on another computing node of the computing cluster; sending a request for the data object to a first handler process running on the first computing node, the request being sent by the first process; sending the request to a second handler process running on a second computing node wherein the second process is operating; retrieving the data object from the second process by directly accessing the memory allocated for the second process; transferring the data object to the first handler process; and placing the data object directly into the memory allocated for the first process on the first computing node, the placing being accomplished by the first handler process.

The present invention may further comprise a method of sharing data between two processes on a multi-node computing cluster comprising the steps of: determining that a data object needs to be updated by a first process operating on a first node of the cluster; querying a lookup table to determine that the data object is located in a second process running on another computing node of the cluster, the lookup table having at least the location of data objects as either on the first computing node or on another computing node of the computing cluster; sending the data object to a first handler process running on the first computing node, the data object being sent by the first process; sending the data object to a second handler process running on a second computing node wherein the second process is operating; and placing the data object into the second process by directly accessing the memory allocated for the second process.

The present invention may further comprise a method of sharing data between two processes on a multi-node computing cluster comprising the steps of: determining that a data object needs to be updated by a first process operating on a first node of the cluster; querying a lookup table to determine that the data object is located in a second process running on the first node of the cluster, the lookup table having at least the location of data objects as either on the first computing node or on another computing node of the computing cluster; and placing the data object into the second process by directly accessing the memory allocated for the second process.

The present invention may further comprise a multi-node computing system comprising: a plurality of computers, each of the computers comprising at least one processor and a memory system; at least one computational process operating on each of the plurality of computers and adapted to have a table of links for each data object associated with the computational processes and further adapted to indicate whether the data objects are located on the local node or a remote node; a handler process operational on each of the plurality of computers and adapted to send and receive requests for data objects and further adapted to access the memory of the local processes in order to store and retrieve data objects from the memory without disturbing the local processes.

The advantages of the present invention are that multiple processes operating on one or more processors may share data without disturbing other ongoing processes. Further, a computational task may be executed on different number of processors without any additional programming. The number of processors is not limited. The present invention minimizes network traffic and memory requirements among the individual computers of a cluster because data is efficiently shared and communicated. The benefits of a direct memory access multiprocessor model are achieved across a networked computer cluster.

### BRIEF DESCRIPTION OF THE DRAWINGS

In the drawings,

FIG. 1 is an illustration of an embodiment of the present invention of a distributed parallel computer system in a cluster of computers with one or more processors wherein data object may be shared between computers.

FIG. 2 is an illustration of an embodiment of the present invention wherein two compute nodes interact.

FIG. 3 is an illustration of a timeline progression of the various events of an example of retrieving a remote and a local data objects from other processes.

### DETAILED DESCRIPTION OF THE INVENTION

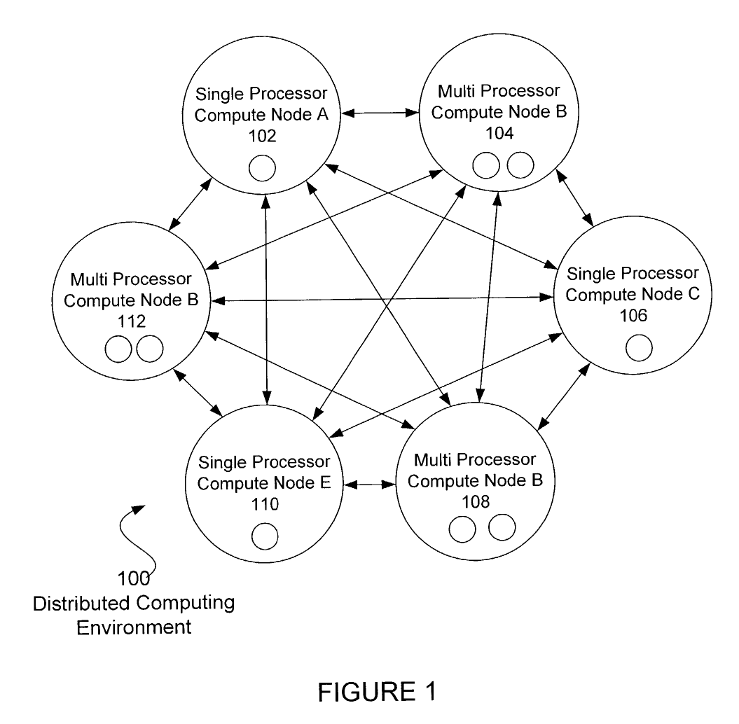

FIG. 1 illustrates an embodiment 100 of the present invention of a distributed parallel computer system in a cluster of computers with one or more processors wherein data object maybe shared between computers. Six compute nodes 102, 104, 106, 108, 110, and 112 are shown some with two processors as in 104, 106, 108. Each compute node may communicate or share data with another compute node as needed.

Each compute node may have one or more computational processes that have independent data storage in a shared memory. The data store is directly accessible by the computational process as well as a handler process that is capable of placing and retrieving data from a process's data storage without disturbing the on-going computation of the computational process. The handler processes operating on each computational node is capable of communication across a network in order to transfer data objects from one computational process to another. It is not required that all of the nodes be of the same or even similar configuration. For example, one node may be a single processor computer operating at a certain speed with a certain amount of memory while a second node may be a multi-processor computer operating at a higher speed with substantially more memory.

In one embodiment, the cluster 100 may be several computers located on a high speed network. The network may be a standard TCP/IP protocol, Ethernet network or any other communications network adapted to transmit and receive communications between computers. In some embodiments, the various computational nodes may be located in very close proximity, such as mounted to a common hardware backplane. In other embodiments, the computational nodes may be connected through the Internet and located at various points around the world. Any network may be used without violating the spirit and intent of the present invention.

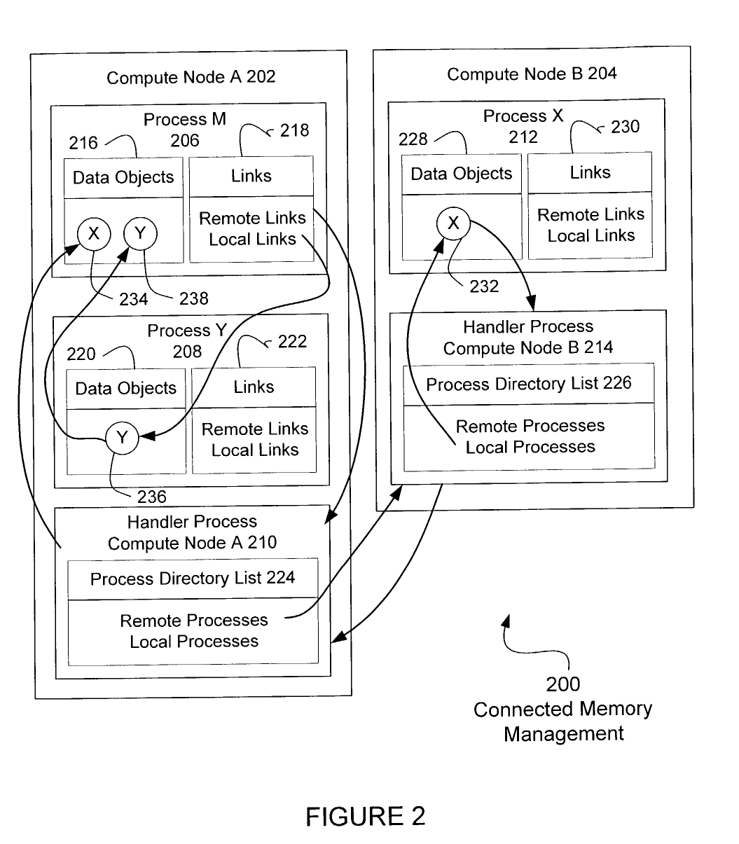

FIG. 2 illustrates an embodiment of the present invention wherein two compute nodes 202 and 204 interact. Compute node 202 has Process M 206 and Process Y 208 performing computational tasks while Handler Process 210 is also running. Compute node 204 has Process X 212 and a Handler Process 214.

Process M 206 has a data store 216 comprising data objects, and a link table 218 comprising links to all of the data objects that are needed by Process M 206.

Correspondingly, Process Y 208 has data store 220 and link table 212 as Process X 212 has data store 228 and link table 230. The Handler Process 210 has process directory list 224 and Handler Process 214 has process directory list 226.

For example, Process M 206 may request updates to two data objects, X 234 and Y 238. The link table 218 may indicate that object X is stored on a remote process, so a request is sent to Handler Process 210. The Handler Process consults the process directory list 224 and forwards the request to the Handler Process 214, which consults the process directory list 226 to determine that the requested object is stored on the local compute node 204. The Handler Process 214 retrieves the data object X 232 directly from the data store 228 without disturbing the ongoing computational Process X 212. The Handler Process 214 sends the data object to Handler Process 210, which places the updated data object X 234 in the data store 216 of computational process 206.

In order to update data object Y 238, Process M 206 consults the link table 218 to determine that the data object is located locally, in Process Y 208. The Process M 206 is then able to directly access data object Y 236 from the data store 220 and transfer the data object Y 236 to the data store 216.

In the above example, the various computational processes are able to continue processing without having to service requests from other processes. Those processes that are running on the same compute node, such as Process M 206 and Process Y 208, are able to directly access the data store associated with the other process. In this fashion, the present embodiment operates with equivalent speed and benefits of a shared memory multiprocessor system.

In the case where a data object is located on a remote compute node, the handler processes 210 and 214 are able to efficiently communicate and access the necessary data without having to disturb the ongoing computational processes. While such transactions are not as streamlined and fast as a traditional shared memory system, many more nodes are able to be connected to each other. Further, the individual computational nodes may be different computers from different vendors and may have different operating systems.

In some embodiments, a compute node may have multiple processors. In such cases, one of the processors may handle operating system tasks as well as the handler process while the remaining processor or processors may strictly perform computational processes. In such an embodiment, the computational processes may operate at full speed on the separate processors while having the overhead functions, including the handler process, handled by the first processor. Those skilled in the art will appreciate that the present invention is not constrained to either multiprocessor or single processor computational nodes.

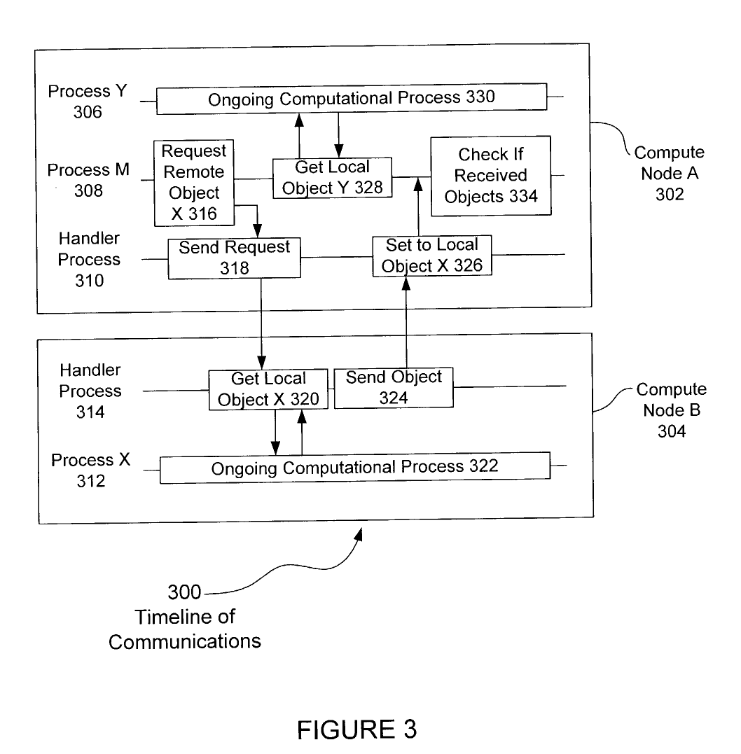

FIG. 3 illustrates a timeline progression of the various events of the previous example of retrieving a remote and a local data object from other processes. Compute node A 302 and compute node B 304 are shown. Compute node A 302 has Process Y 306, Process M 308, and Handler Process 310 executing simultaneously. Compute node B 304 has Process X 312 and Handler Process 314 executing simultaneously.

Process M 308 is to retrieve data object X and data object Y from Process X 312 and Process Y 306, respectively. Process M 308 requests object X in block 316, wherein a request is sent in block 318 by Handler Process 310 to Handler Process 314. Handler Process 314 then gets the local object X from Process X 312 in block 320 while not disturbing Process X 312. The Handler Process 314 then sends the object to Handler Process 310 in block 324. Handler Process 310 then updates the data object X in the data store of Process M in block 326. Process M 308 retrieves data object Y directly from Process Y 306 in block 328 without disturbing the ongoing computation of Process Y in block 330. After transferring the required data, Process M 308 checks to see if all requested objects are received in block 334 before continuing further computation.

The present example has shown where a process may request data from other processes that are either local or remote. Each computational process has the ability to directly access data from other locally running processes. This ability allows the local processes to operate with the speed and efficiency of shared memory processes. It may not be necessary for a process to use the concurrently operating handler process to access data on the local node. In some embodiments, it may be possible for the handler process to perform the local retrieval of data from other processes. In such embodiments, all of the requests for data would therefore travel through the handler process.

The present invention is not restricted to processing requests for collecting data. In some embodiments, data may be dispersed or pushed from one process to one or more other processes. For example, as a first process updates a data object that may be used by a second process, the first process may transfer the data object to a handler process, which in turn transfers the data object to a handler process on a second compute node, which in turn places the data object in the data store of the second process. In this manner, data may be dispersed about a computer cluster.

Network traffic is kept to a minimum in the present invention. Only the necessary data is required to be transferred from a first node to a second node. By minimizing the network traffic, higher numbers of compute nodes may operate efficiently with a given network.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of sharing data between two processes on a multi-node computing cluster comprising the steps of:
determining that a data object needs to be updated by a first process operating on a first node of said cluster;
querying a lookup table to determine that said data object is located in a second process running on another computing node of said cluster, said lookup table having at least the location of data objects as either on said first computing node or on another computing node of said computing cluster;
sending a request for said data object to a first handler process running on said first computing node, said request being sent by said first process;
sending said request to a second handler process running on a second computing node wherein said second process is operating;
retrieving said data object from said second process by directly accessing the memory allocated for said second process;
transferring said data object to said first handler process; and
placing said data object directly into the memory allocated for said first process on said first computing node, said placing being accomplished by said first handler process.

2. The method of claim 1 wherein said first node comprises a multi-processor computer.

3. The method of claim 1 wherein said first node comprises a single-processor computer.

4. The method of claim 2 wherein said first process operates on a first processor of said first node and said handler process operates on a second processor of said first node.

5. The method of claim 2 wherein said second node comprises a multi-processor computer.

6. The method of claim 2 wherein said second process operates on a first processor of said second node and said handler process operates on a second processor of said second node.

7. A method of sharing data between two processes on a multi-node computing cluster comprising the steps of:
determining that a data object needs to be updated by a first process operating on a first node of said cluster;
querying a lookup table to determine that said data object is located in a second process running on another computing node of said cluster, said lookup table having at least the location of data objects as either on said first computing node or on another computing node of said computing cluster;
sending said data object to a first handler process running on said first computing node, said data object being sent by said first process;
sending said data object to a second handler process running on a second computing node wherein said second process is operating; and
placing said data object into said second process by directly accessing the memory allocated for said second process.

8. The method of claim 7 wherein said first node comprises a multi-processor computer.

9. The method of claim 7 wherein said first node comprises a single-processor computer.

10. The method of claim 8 wherein said first process operates on a first processor of said first node and said handler process operates on a second processor of said first node.

11. The method of claim 8 wherein said second node comprises a multi-processor computer.

12. The method of claim 8 wherein said second process operates on a first processor of said second node and said handler process operates on a second processor of said second node.

13. A method of sharing data between two processes on a multi-node computing cluster comprising the steps of:
determining that a data object needs to be updated by a first process operating on a first node of said cluster;
querying a lookup table to determine that said data object is located in a second process running on said first node of said cluster, said lookup table having at least the location of data objects as either on said first computing node or on another computing node of said computing cluster; and
placing said data object into said second process by directly accessing the memory allocated for said second process.

14. The method of claim 13 wherein said first node comprises a multi-processor computer.

15. The method of claim 13 wherein said first node comprises a single-processor computer.

16. The method of claim 14 wherein said first process operates on a first processor of said first node and said handler process operates on a second processor of said first node.

17. The method of claim 14 wherein said second node comprises a multi-processor computer.

18. The method of claim 17 wherein said second process operates on a first processor of said second node and said handler process operates on a second processor of said second node.

19. A multi-node computing system comprising:
a plurality of computers, each of said computers comprising at least one processor and a memory system;
at least one computational process operating on each of said plurality of computers and adapted to have a table of links for each data object associated with said computational processes and further adapted to indicate whether said data objects are located on the local node or a remote node;
a handler process operational on each of said plurality of computers and adapted to send and receive requests for data objects and further adapted to access the memory of the local processes in order to store and retrieve data objects from said memory without disturbing said local processes.

20. The multi-node computer system of claim 19 wherein at least one of said computers comprises a multi-processor computer.

21. The multi-node computer system of claim 19 wherein each of said computers comprises a single-processor computer.

22. The multi-node computer system of claim 20 wherein said computational process operates on a first processor of said multi-processor computer and said handler process operates on a second processor of said multi-processor computer.
